(19) United States
(12) Patent Application Publication
(10) Pub. No.: US 2004/0031055 A1
(43) Pub. Date: Feb. 12, 2004

(54) Method for constructing and transmitting guidance information for IPPV service in digital cable broadcasting

(76) Inventors: Joon Young Jung, Daegu (KR); O Hyoung Kwon, Daejon (KR); Chieteuk Ahn, Daejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/420,305

(22) Filed: Apr. 22, 2003

(30) Foreign Application Priority Data
Aug. 7, 2002 (KR) 2002-46520

(51) Int. Cl. H04N 7/16; H04N 7/173

(52) U.S. Cl. 725/104; 725/1

(57) ABSTRACT

Provided is a method for constructing and transmitting guidance information for impulse pay-per-view (IPPV) broadcasting service, and a computer-readable recording medium for recording a program that implements the method. The method of the present research includes the step of: inserting an IPPV service descriptor, which is suggested as a standard data structure for transmitting IPPV service purchase guidance information, to an aggregate event information table; and transmitting the aggregate event information table.

### FIELD OF THE INVENTION

The present invention relates to a digital cable television broadcasting; and, more particularly, to a method for constructing and transmitting impulse pay-per-view (IPPV) program guidance information for providing IPPV service.

### DESCRIPTION OF RELATED ART

Cable television (TV) broadcasting studios have provided basic audio and video services only, just as the conventional analogue broadcastings. However, as broadcasting becomes digitalized, cable TV broadcasting has reached the level of providing interactive TV broadcasting services, as well as multimedia services. Particularly, local digital cable broadcasting studios are adopting an Open Cable standard, which is used across the globe, and the service based on the Open Cable standard is about to be in service.

At present, local pay TV services are divided largely into cable broadcasting and satellite broadcasting. The digital cable broadcasting provides the interactive service basically through the cable network. Therefore, the digital cable broadcasting has an advantage over the satellite broadcasting, which provides interactive service through a public switched telephone network (PSTN), that it can provide much more diverse services.

Accordingly, in the digital cable broadcasting, various charged services can be sprung out, such as interactive TV, games, Internet, and the like. An impulse pay-per-view (IPPV) service, to which the present invention is applied, is one of the charged services.

FIG. 1 is a block diagram showing a structure of an interactive broadcasting transmission/reception system in accordance with an embodiment of the present invention. As illustrated in the drawing, the broadcasting channel is divided into two. One is a broadcasting channel or in-band channel 11 that transmits broadcasting data, and the other one is an interactive channel or out-of-band channel 12 that receives/transmits auxiliary data for broadcasting and interactive communication data.

The digital cable broadcasting system shown in FIG. 1 includes: a broadcasting service provider 101 for providing multimedia data including audio and video information; an interactive service provider 102 for providing interactive contents; a broadcasting network adapter 103 for constructing the data from the broadcasting service provider 101 and interactive service provider 102 into broadcasting signals and sending out the broadcasting signals to a broadcasting transmission medium 105; an interactive network adapter 104 for transmitting interactive communication and auxiliary data with the cable subscriber, and administrating a subscriber's receiver; a broadcasting transmission medium 105 formed of optical cable and/or coaxial cable; an interactive network 106 for forming a communication network, such as asynchronous transfer mode (ATM) and Internet protocol (IP) using the cable network; a restrictive reception module 112 for restricting subscription with respect to charged broadcasting service; and a subscriber's receiver 107 for receiving broadcasting and providing interactive service.

The subscriber's receiver 107 includes a network interface unit 108 having a broadcasting network interface module 110 for receiving a broadcasting signal from the broadcasting transmission medium 105 and an interactive network interface module 111 for receiving interactive data from the interactive network 106 and transmitting a response signal thereto; and a broadcasting reception unit 109 for converting the broadcasting signal into multimedia data containing audio and/or video data. Particularly, the interactive network interface module 111 is interfaced with the restrictive reception module 112, which is again interfaced with the broadcasting reception unit 109.

In the digital cable broadcasting system of FIG. 1, a broadcasting program is transmitted through an in-band channel 11, and the auxiliary information including channel and program guidance information and the restrictive reception data is transmitted through an out-of-band channel 12.

The Open Cable standard defines service information (SI) for transmitting channel and program guidance information. SI standard is a structure of data that are transmitted from a transmitting end to a receiving end to thereby make a subscriber to watch a channel he or she wants and perform electronic program guiding (EPG). It is essential for viewing and hearing digital cable broadcasting. The SI standard is formed in a table whose data structure is Motion Picture Experts Group (MPEG)-2 Private Section.

The form of service information data follows the structure of Private Section which is defined in the international standardization organization (ISO)/international electrotechnical commission (IEC) 13818-1 (MPEG-2 Part I).

The tables suggested in the SI standard includes following information:

NIT: Information on a structure of a cable broadcasting network (channel frequency, transmission system, modulation mode, etc.)

NTT: Name information of each channel source forming a cable broadcasting network

S-VCT: Information on a virtual channel provided in a cable broadcasting service

STT: Standard time information

MGT: Information on each of the transmitted SI tables (whether there is a change, etc.)

L-VCT: Information on a virtual channel provided in a cable broadcasting service

RRT: broadcasting grade information of the current service area

AEIT (Aggregate Event Information Table): Program guidance information on the service channels (program starting time, video data, audio data, etc.)

AETT: Information on the titles and briefs of the programs served on each channel

Here, AEIT is an essential table for the subscriber's receiver 107 to perform electronic program guiding (EPG). AEIT provides information on how the programs of the cable broadcasting channels are drawn up from a transmitting end to a receiving end. That is, information, such as what and when a program is aired on which channel, the audio information and grade information of the program, and whether the program has a caption or not, is provided. A MPEG-2 User Private Descriptor type of data may be inserted in AEIT.

The service information data that are transmitted through the out-of-band channel 12 is processed in the subscriber's receiver, which is described in FIG. 2. FIG. 2 is an exemplary diagram illustrating the process of service information transmitted from a cable subscriber's receiver to an out-of-band channel in the interactive broadcasting transmission/reception system in accordance with an embodiment of the present invention.

The Quadrature Phase Shift Keying (QPSK)-modulated service information data stream is received in a QPSK receiving unit 201 in the interactive network interface module 111 of the subscriber's receiver 107, and then after QPSK modulation, it is transmitted to the restrictive reception module 112.

The restrictive reception module 112 analyzes the service information data, uses the analyzed data in a restrictive reception module application, and transmits it to the subscriber's receiver 107 in the form of MPEG-2 Private Section.

The subscriber's receiver 107 provides such application as channel navigation and electronic program guiding to a subscriber by using the service information data received from the restrictive reception module 112.

That is, the broadcasting program aired through the in-band channel 11 can be viewed by the service information transmitted through the out-of-channel 12.

The IPPV program, which is one of the charged services, can be viewed to a subscriber only after it is purchased by the subscriber. That is, IPPV can be provided at the purchase request of the subscriber. To buy the program, the subscriber needs to know additional information, such as program price, program starting time, and if it is recordable or not. The Open Cable standard defines the purchase guidance information used in the interface between the subscriber's receiver and the restrictive reception module 112. Followings are the purchase guidance information.

“Purchase_type” indicates the purchase type of an IPPV program,

“Purchase_price” indicates the purchase price of the IPPV program,

“Purchase_validation” indicates the validation level of the IPPV program,

“Expiration_date” indicates the expiration time of the IPPV program,

“Program_start_time” indicates the starting time of the IPPV program,

“Initial_Free_preview_duration” indicates the time for free-watching the IPPV program after the IPPV program is started,

“Anytime_free_preview_duration” indicates the time for free-watching the IPPV program during the showing of the IPPV program,

“Title_txt” indicates the title of the purchase option, and “Text_txt” indicates the text of the purchase option.

The above are program purchase guidance information provided by the restrictive reception module 112, when the subscriber buys a particular IPPV program using his subscriber's receiver 107. The information is included in a program confirmation message that is transmitted from the restrictive reception module 112 to the subscriber's receiver 107, when an IPPV program purchase request message is transmitted from the subscriber's receiver 107 to the restrictive reception module 112. That is, the above information should be shown as guidance information on the program, when the subscriber has selected the program in the electronic program guidance application.

To provide such information to the subscriber, it should be transmitted from the cable broadcasting service provider to the subscriber's receiver, whatever the form of the information transmission is. However, in the current Open Cable standard, there is no regulation on the data structure and transmission protocol for transmitting such information from the cable broadcasting service provider to the subscriber's receiver.

In short, to provide IPPV service in a digital cable broadcasting system that follows the Open Cable standard, the IPPV purchase guidance information described above should be transmitted from the broadcasting service provider to the subscriber's receiver. Therefore, the structure and protocol of the transmission data should be defined.

Furthermore, the IPPV purchase guidance information that follows the Open Cable standard contains only the information for purchase and does not have any information on what program is provided on which channel. So, a message header data for transmitting a particular message should be defined, other than the conventional IPPV purchase guidance information data in order to transmit the additional information needed for IPPV purchase to the subscriber's receiver independently. Along with the message header data, data (e.g., source ID, event ID, program number, etc.) that informs what program of which channel is concerned in such additional purchase guidance information should be added, too.

### SUMMARY OF THE INVENTION

It is, therefore, an object of the present invention to provide a method for constructing and transmitting impulse pay-per-view (IPPV) service guidance information for providing IPPV service in a digital cable broadcasting. The method can transmit all the guidance information needed for a subscriber to purchase a program from a cable broadcasting provider by defining IPPV service descriptors according to the form of Motion Picture Experts Group (MPEG)-2 Private Descriptor, which is defined in the international standardization organization (ISO)/international electro-technical commission (IEC) 13818-1 (MPEG-2 Part I) based on the data suggested for the Open Cable standard, including the defined IPPV service descriptors in AEIT, which is defined in the Open Cable standard ‘Society of Communications Engineers (SCTE) Digital Video Subcommittee (DVS) 234rev.2’, and transmitting them. The present invention also provides a computer-readable recording medium for recording the data having the above data structure. Thanks to the IPPV service purchase guidance information, cable broadcasting subscribers can purchase IPPV programs more conveniently.

In accordance with an aspect of the present invention, there is provided a method for transmitting guidance information for impulse pay-per-view (IPPV) broadcasting service in a digital cable television broadcasting, comprising the step of: inserting an IPPV service descriptor, which is suggested as a standard data structure for transmitting IPPV service purchase guidance information, to an aggregate event information table; and transmitting the aggregate event information table.

In accordance with another aspect of the present invention, there is provided a computer readable recording medium for recording a program for implementing a method for transmitting guidance information for impulse pay-per-view (IPPV) broadcasting service in a digital cable television broadcasting system provided with a processor, the method comprising the steps of: inserting an IPPV service descriptor, which is suggested as a standard data structure for transmitting IPPV service purchase guidance information, to an aggregate event information table; and transmitting the aggregate event information table.

In accordance with another aspect of the present invention, there is provided a computer readable recording medium for recording: 8-bit descriptor tag data for identifying descriptors; 8-bit descriptor length data for indicating the entire length of the descriptor information except the descriptor tag information and the length of the descriptor length information; 8-bit transaction type data for indicating purchase information of an event (i.e., the IPPV program); 16-bit transaction price data for indicating the purchase price information of the IPPV program; 8-bit transaction validation data for indicating a level for a restrictive reception unit of a subscriber's receiver to allow the purchase of the program, the restrictive reception unit restricting viewing for charged broadcasting service; 32-bit expiration data for indicating the expiration time of the program; 32-bit starting time data for indicating the starting time of the program; 16-bit initial free preview duration data for indicating free preview time from the starting time of the program; 16-bit anytime free preview duration data for indicating free preview time during the showing of the program; and text data for showing purchase options of the program and the description on the purchase options.

The method of the present invention can provide the IPPV purchase guidance information to the subscriber's receiver efficiently by using the MPEG-2 User Private Descriptor, and including the data formatted IPPV Service Descriptor in AEIT of SI and transmitting them in order to send out the data defined for IPPV service from the transmitting end to the receiving end.

That is, since the IPPV purchase guidance information is formatted into the MPEG-2 User Private Descriptor and transmitted being included in AEIT, the IPPV purchase guidance information could be provided to the subscriber efficiently without any additional information to be transmitted to the subscriber's receiver, and then processed easily in the restrictive reception module of the subscriber's receiver.

When the subscriber attempts to purchase a particular IPPV program through the electronic program guidance (EPG) based on the data of AEIT, the restrictive reception module refers to an IPPV service descriptor which is included in AEIT and corresponds to the selected program and informs the purchase guidance information of the selected program. Consequently, the electronic program guidance and IPPV purchase guidance information can be processed consistently within the AEIT.

Following description explains only the principle of the present invention. Any one skilled in the art can embody the principle of this invention and invent various apparatuses within the concept and scope of the present invention, even though they are not described or illustrated in the specification clearly. Also, all the conditional terms and embodiments used in this specification are basically used only for the purpose of understanding people the concept of the present invention, and they should be construed not limited to the described embodiments and conditions. In addition, the principle, viewpoint and embodiments of the present invention as well as all the detailed description on the particular embodiments should be construed to include their structural and functional equivalents. The equivalents include not only the currently known ones, but the ones to be developed in future as well. In short, they include all devices developed to perform the same function, regardless of their structures.

Accordingly, for example, the block diagrams of the present invention should be understood illustrating the conceptual viewpoint of an exemplary circuit that embodies the principle of the present invention. Similarly, all the flow charts, state conversion and pseudo-codes can be substantially embodied in a computer-readable medium, and expressed in the form of diverse processes that are performed by a computer or a processor, whether or not the, computer or processor is illustrated clearly.

The diverse functions of a device, which is illustrated in a drawing to be a processor or to have a functional block having the similar concept can be provided not only in the form of a separate hardware for a particular use only, or a hardware that is related to a proper software for and implements the software. When the above function is provided by a processor, the processor could be a single processor for the use only, a single shared processor or a plurality of individual processors, part of which can be shared. Also, the use of such terms as a processor, a controller, or others used in the similar concept should not be construed to be citing only a hardware that implements a software, but should be understood to implicitly include a digital signal processor (DSP), and a CD ROM, RAM, and non-volatile memory for storing a software, as well as other types of hardware. Similarly, the switch shown in the drawings may be ones presented conceptually only. The functions of the switch should be understood, too, to be one that is operated in a program logic or a proprietary logic to control a program, or implemented manually, or through interaction between the program control and the proprietary logic. A particular technology can be selected by a designer to help understand the method of the present invention.

In the claims of the present invention, the constitutional parts, which are expressed as means for performing the function described in the detailed description of the invention, include all the methods that perform the function including all sorts of software, such as a combination of circuits performing the function, firmware or micro codes. The constitutional parts are connected to a proper circuit for performing the software. The method of the present invention, which is defined in the following claims, is a combination of functions provided by various means, which are connected to each other in a way requested in the claim, too. Any means that can provide the function described in the specification should be understood the same as what is figured out from this specification.

### BRIEF DESCRIPTION OF THE DRAWINGS

The above and other objects and features of the present invention will become apparent from the following description of the preferred embodiments given in conjunction with the accompanying drawings, in which:

FIG. 1 is a block diagram showing a structure of an interactive broadcasting transmission/reception system in accordance with an embodiment of the present invention;

FIG. 2 is an exemplary diagram illustrating the process of service information transmitted from a cable subscriber's receiver to an out-of-band channel in the interactive broadcasting transmission/reception system in accordance with an embodiment of the present invention;

FIG. 3 is a diagram describing a purchase type of an impulse pay-per-view (IPPV) service in the architecture of an IPPV service descriptor for transmitting IPPV service purchase guidance information in accordance with an embodiment of the present invention;

FIG. 4 is a diagram describing a purchase price of an IPPV service in an architecture of an IPPV service descriptor for transmitting IPPV service purchase guidance information in accordance with an embodiment of the present invention; and

FIG. 5 is a diagram describing a purchase permission of an IPPV service in the architecture of an IPPV service descriptor for transmitting IPPV service purchase guidance information in accordance with an embodiment of the present invention.

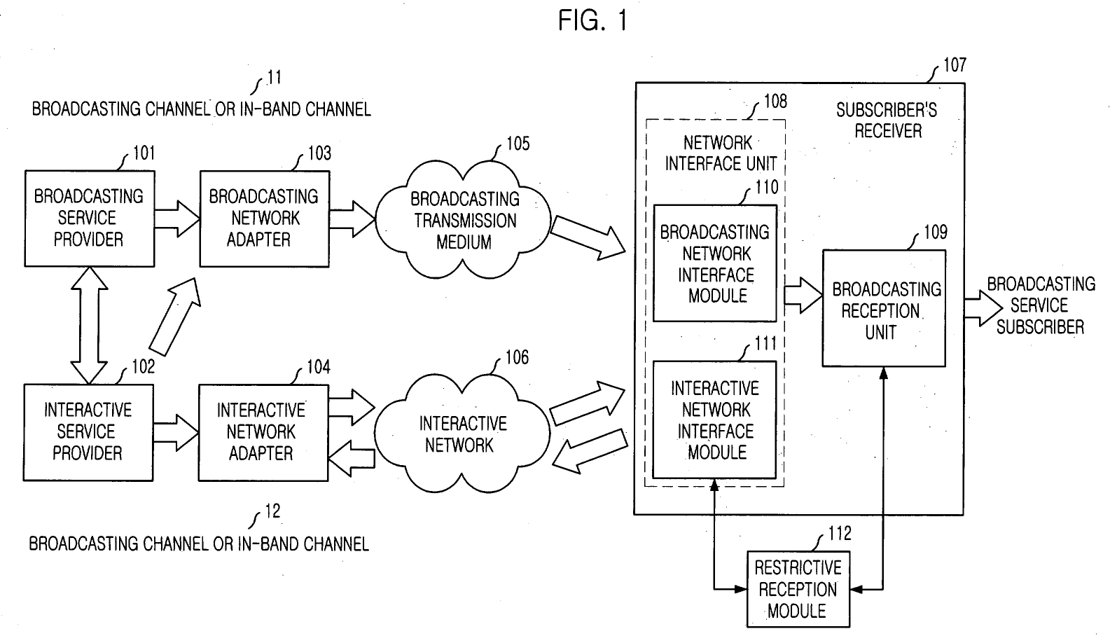

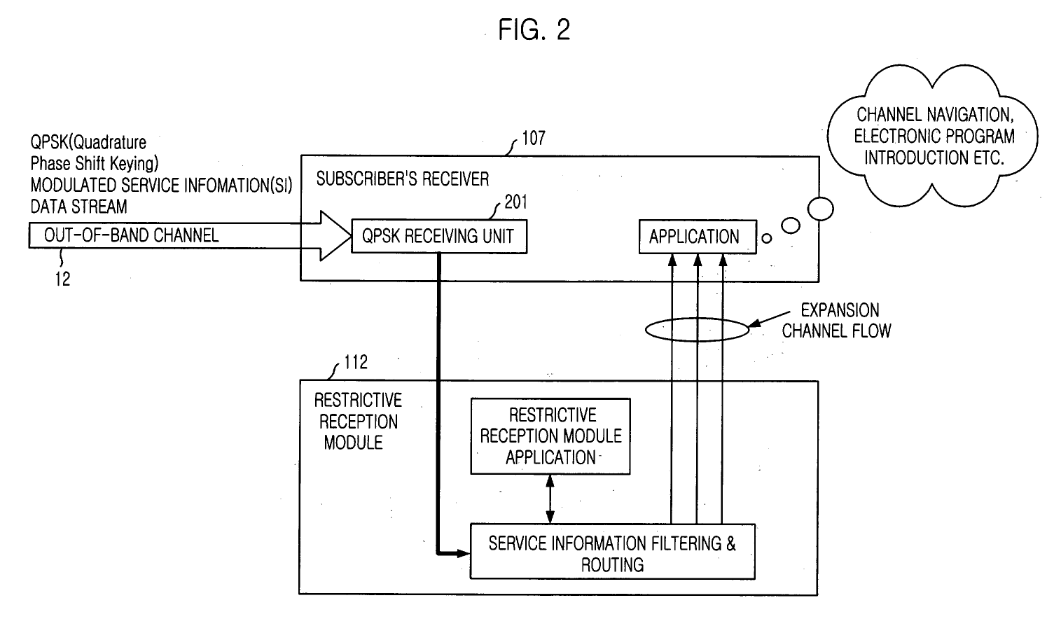

### DETAILED DESCRIPTION OF THE INVENTION

Other objects and aspects of the invention will become apparent from the following description of the embodiments with reference to the accompanying drawings, which is set forth hereinafter. The same reference numeral is given to the same constituent, although it appears in different drawings. In addition, any description which may blur the point of the present invention is omitted in the specification.

Information on channels and programs is transmitted from a digital cable broadcasting provider to a service information (SI) table, which is defined in a Moving Picture Experts Group (MPEG)-2 Private Section, via out-of-band channel. An Aggregate Event Information Table (AEIT) among the service information tables includes guidance information for the programs (i.e., events) of the channels.

Among the guidance information in the AEIT is guidance information for an impulse pay-per-view (IPPV) program. However, the AEIT has general guidance information on the IPPV program, and it does not provide information needed for the purchase of the IPPV service.

Accordingly, this problem called for the present invention, which suggests a method for transmitting information needed for the purchase of an IPPV program. The method of the present invention adopts the structure of a Moving Picture Experts Group (MPEP)-2 User Private Descriptor. The MPEG-2 user private descriptor is inserted in a service information (SI) table, especially AEIT, and transmitted. It has an advantage that it can provide information only on IPPV programs. Also, the MPEG-2 user private descriptor makes it possible to manage the information, just as it does with other programs, consistently. That is, the method of the present invention transmits an IPPV purchase guidance information in a digital cable television (TV) broadcasting by using the MPEG-2 user private descriptor as a standard data structure, and transmits transmission protocol by inserting it in AEIT among the SI tables, the SI tables being transmitted through an out-of-band channel.

Table 1 describes IPPV service descriptors that define the standard data structure of the IPPV purchase guidance information based on the user private descriptors in accordance with the present invention.

TABLE 1

| | Syntax | Bits | Bytes | Format |
|---|---|---|---|---|
| ippv_service_descriptor ( ){ | | | | |
| | descriptor_tag | 8 | 1 | Uimsbf |
| | descriptor_length | 8 | 1 | Uimsbf |
| | purchase_type | 8 | 1 | Uimsbf |
| | purchase_price | 16 | 2 | Uimsbf |
| | purchase_validation | 8 | 1 | Uimsbf |
| | expiration_date | 32 | 4 | Uimsbf |
| | Program_start_time | 32 | 4 | Uimsbf |
| | initial_free_preview_duration | 16 | 2 | Uimsbf |
| | anytime_free_preview_duration | 16 | 2 | Uimsbf |
| | title_length | 8 | 1 | Uimsbf |
| | for (J=0;J<title_length;J++){ | 8 | 1*J | Uimsbf |

title_txt

| | | | |
|---|---|---|---|
| } | | | |
| text_length | 8 | 1 | Uimsbf |
| for (K=0;K<text_length;K++) { | | | |

| | | | |
|---|---|---|---|
| text_txt | 8 | 1*K | Uimsbf |

}

As shown in Table 1, the IPPV service descriptors have following fields.

First, the “descriptor_tag” field, which is composed of eight bits, designates a value for each descriptor according to an Open Cable standard to identify the descriptor. Each descriptor has a value in the range of the values that are presented in the current Open Table standard from O×CO to O×FE based on the user's definition.

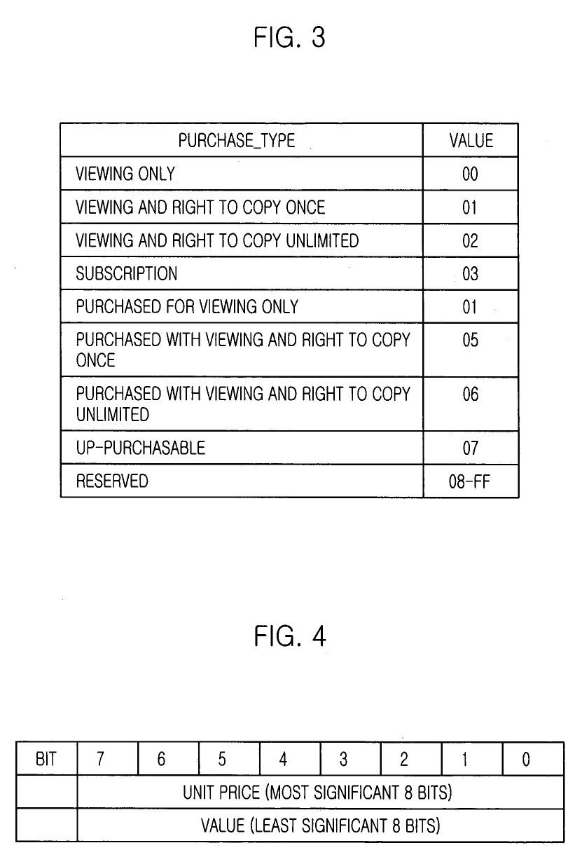

The “descriptor_length” field, composed of eight bits, instructs the entire length of the subsequent descriptors, and the “purchase_type” field, also composed of eight bits, instructs how the corresponding event (i.e., IPPV program) can be purchased. FIG. 3 shows purchase types which are different according to the “purchase type” field value. Following is the description on the values of FIG. 3.

The “viewing only” field denotes that a corresponding program can be purchased only for the purpose of viewing. The “viewing and right to copy once” field denotes that the program can be bought for the purpose of viewing and one-time copying only. The “viewing and right to copy unlimited” field indicates that the program can be purchased for the purpose of viewing and right to copy unlimited times.

The “subscription” field denotes that the corresponding program cannot be bought as an IPPV program, because it is a charged regular program. The “purchased for viewing only” field denotes that the program is allowed for viewed only, and the purchase is completed. The “purchased with viewing and right to copy once” field denotes that the corresponding program is allowed for viewing and one-time copying, and the program purchase is completed. The “purchased with viewing and right to copy unlimited” field denotes that the corresponding program is allowed for viewing and right to copy unlimited times, and the purchase is completed. The “unpurchasable” field denotes that the program cannot be purchased.

Meanwhile, the “purchase_price” field, which is composed of 16 bits, shows the price information of a program. As illustrated in FIG. 4, the price of the program is given as a multiplication of the unit price and the value presented in the “purchase_price” field. For example, if the unit price is five cents and the value is 79, the amount comes to $3.95. To take an example of a domestic case, when the unit price is 50 won and the value is 20, the amount comes to 1000 won.

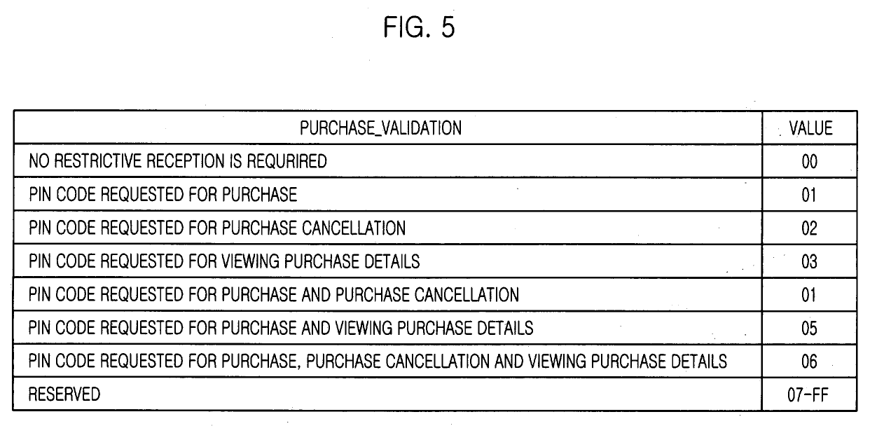

The “purchase_validation” field, which is composed of eight bits, defines the level for allowing the program purchase which is requested by a restrictive reception module. The values of the “purchase_validation” field are as defined in FIG. 5.

If the value of the “purchase_validation” field is “00”, it means that restrictive broadcasting reception is not required. The value “01” denotes that a personal identification number (PIN) code is requested for purchase. Here, the PIN code is a sort of password assigned to each cable service. That is, when a certain broadcasting service is purchased, the PIN code is requested to prevent the purchase of the service by those who are not subscribers. The value “02” means that the PIN code is requested to cancel the purchase, and the value “03” denotes that the PIN code is requested to view the purchase details. The value “04” denotes that the PIN code is requested to perform or cancel the purchase, and the value “05” denotes that the PIN code is requested to perform purchase and view the purchase details. The value “06” denotes that the PIN code is requested to perform or cancel purchase and view the purchase details. The other field area (07-FF) is a reserved area.

The “expiration_data” field is composed of 32 bits and it directs the expiration time of a corresponding program. It is expressed on the basis of second from 12 o'clock a.m., Jan. 6, 1980.

The “program_start_time” field is composed of 32 bits, and it directs the starting time of a corresponding program. It is expressed on the basis of global positioning system (GPS) second from 12 o'clock a.m., Jan. 6, 1980.

The “initial_free_preview_duration” field is composed of 16 bits, and it instructs the time for free-viewing a corresponding program from the starting time of the program.

The “anytime_free_preview_duration” field is composed of 16 bits, and it shows the time for free-viewing a corresponding program during the showing of the program.

The “title_txt” field denotes the purchase option of a corresponding program, and the “text_txt” field shows the description on the purchase option of the program.

An IPPV service descriptor having the above information is included in AEIT among the SI tables and transmitted to the restrictive reception module 112 through the out-of-band channel 12.

The restrictive reception module 112 receives the IPPV service descriptor included in the AEIT on an application and provides the purchase guidance information to a subscriber's receiver 107, when it receives an IPPV service purchase request. Also, the restrictive reception module 112 prevents a subscriber from viewing an IPPV program he has not purchased, using the information.

The IPPV service descriptor having the above information has a format of Uimsbf (unsigned integer, most significant bit first), which stands for an integer value without a sign. The format interprets the transmitted information from the most significant bit first.

Most desirably, the IPPV service descriptor shown in Table 1 is included in the AEIT among other SI tables and transmitted to a subscriber's receiver. The AEIT having the IPPV service descriptor in accordance with the present invention is shown in Table 2 below.

TABLE 2

| Syntax | | Bits | Bytes | Format |
|---|---|---|---|---|
| aggregate_event_information_table_section( ){ | | | | |
| | table_ID | 8 | 1 | 0xD6 |
| | section_syntax_indicator | 1 | 2 | ‘1’ |
| | private_indicator | 1 | | ‘1’ |
| | reserved | 2 | | ‘11’ |
| | section_length | 12 | | uimsbf |
| | AEIT_subtype | 8 | 1 | uimsbf |
| | MGT_tag | 8 | 1 | uimsbf |
| | reserved | 2 | 1 | ‘11’ |
| | version_number | 5 | | uimsbf |
| | current_next_indicator | 1 | | ‘1’ |
| | section_number | 8 | 1 | uimsbf |
| | last_section_number | 8 | 1 | uimsbf |
| | if (AEIT_subtype= =0) { | | | |

| | | | |
|---|---|---|---|
| num_sources_in_section | 8 | 1 | uimsbf |
| for(j=0;j<num_sources_in_sec- | | | |
| tion;j++) { | | | |

| | | | |
|---|---|---|---|
| source_ID | 16 | (2) | uimsbf |
| num_events | 8 | (1) | uimsbf |
| for(j=0;j<num_events;j++) { | | | |

| | | | |
|---|---|---|---|
| reserved | 2 | ((2)) | ‘11’ |
| event_ID | 14 | | uimsbf |
| start_time | 32 | ((4)) | uimsbf |
| reserved | 2 | ((3)) | ‘11’ |
| ETM_present | 2 | | bslbf |
| duration | 20 | | uimsbf |
| title_length | 8 | ((1)) | uimsbf |
| title_text( ) | var | | |
| reserved | 4 | ((2)) | ‘1111’ |
| descriptors_length | 12 | | |
| for(i=0;i<N;i++) { | | | |

descriptor( )

}

}

}

| | | |
|---|---|---|
| } | | |
| else | N+8 | n |

| | | | |
|---|---|---|---|
| reserved | 32 | 4 | rpchof |

CRC_32

}

In short, the IPPV service descriptor of Table 1 is inserted in the “descriptor( )” loop, which is the third “for” loop of the AEIT shown in Table 2, and provides not only the general guidance information of the IPPV program, but also detailed purchase guidance information to the subscriber's receiver.

The method of the present invention can be embodied as a program and stored in a computer-readable recording medium, such as CD ROM, RAM, floppy disks, hard disks, optical-magnetic disks and the like.

The present invention defines a standard data structure and transmission protocol for providing IPPV service purchase guidance information, which is needed for a broadcasting service provider to offer IPPV service to a subscriber's receiver in a digital cable broadcasting system that follows the Open Cable standard. The method of the present invention can provide purchase guidance information in a most desirable way. The transmitted IPPV purchase guidance service can be used effectively to restrict viewing by unauthorized subscriber in the restrictive reception module.

While the present invention has been described with respect to certain preferred embodiments, it will be apparent to those skilled in the art that various changes and modifications may be made without departing from the scope of the invention as defined in the following claims.

What is claimed is:

1. A method for transmitting guidance information for impulse pay-per-view (IPPV) broadcasting service in a digital cable television broadcasting, the method comprising the steps of:
inserting an IPPV service descriptor, which is suggested as a standard data structure for transmitting IPPV service purchase guidance information, to an aggregate event information table; and
transmitting the aggregate event information table.

2. The method as recited in claim 1, wherein the IPPV service descriptor comprises:
8-bit descriptor tag information for identifying descriptors;
8-bit descriptor length information for indicating the entire length of the descriptor information except the descriptor tag information and the length of the descriptor length information;
8-bit transaction type information for indicating purchase information of an event (i.e., the IPPV program);
16-bit transaction price information for indicating the purchase price information of the IPPV program;
8-bit transaction validation information for indicating a level for a restrictive reception unit of a subscriber's receiver to allow the purchase of the program, the restrictive reception unit restricting viewing for charged broadcasting service;
32-bit expiration information for indicating the expiration time of the program;
32-bit starting time information for indicating the starting time of the program;
16-bit initial free preview duration information for indicating free preview time from the starting time of the program;
16-bit anytime free preview duration information for indicating free preview time during the showing of the program; and
text information for showing purchase options of the program and the description on the purchase options.

3. The method as recited in claim 2, wherein the transaction type information includes at least any one of:
a first information for indicating that the program can be purchased only for the purpose of viewing;
a second information indicating that the program can be purchased for viewing and one-time copying;
a third information for indicating that the program can be purchased for viewing and copying without limitation;
a fourth information for indicating that the program is a charged regular program that cannot be purchased as an IPPV program;
a fifth information for indicating that the program is allowed for the purpose of viewing only, and the program purchase is completed;
a sixth information for indicating that the program is allowed for viewing and one-time copying, and the program purchase is completed;
a seventh information for indicating that the program is allowed for viewing and copying without limitation, and the program purchase is completed; and
an eighth information for indicating that the program cannot be purchased.

4. The method as recited in claim 2, wherein the transaction price information is formed of 8-bit unit price information and 8-bit value information.

5. The method as recited in claim 2, wherein the transaction validation information includes at least any one of:
a first information for indicating that restrictive reception is not required;
a second information for indicating that a personal identification number (PIN) code is requested for purchase;
a third information for indicating that the PIN code is requested to cancel the purchase;
a fourth information for indicating that the PIN code is requested to view the purchase details;
a fifth information for indicating that the PIN code is requested to perform or cancel the purchase;
a sixth information for indicating that the PIN code is requested to perform purchase and view the purchase details; and
a seventh information for indicating that the PIN code is requested to perform/cancel purchase and view the purchase details.

6. A computer readable recording medium for recording a program for implementing a method for transmitting guidance information for impulse pay-per-view (IPPV) broadcasting service in a digital cable television broadcasting system provided with a processor, the method comprising the steps of:
inserting an IPPV service descriptor, which is suggested as a standard data structure for transmitting IPPV service purchase guidance information, to an aggregate event information table; and
transmitting the aggregate event information table.

7. A computer readable recording medium for recording:
8-bit descriptor tag data for identifying descriptors;
8-bit descriptor length data for indicating the entire length of the descriptor information except the descriptor tag information and the length of the descriptor length information;
8-bit transaction type data for indicating purchase information of an event (i.e., the IPPV program);
16-bit transaction price data for indicating the purchase price information of the IPPV program;
8-bit transaction validation data for indicating a level for a restrictive reception unit of a subscriber's receiver to allow the purchase of the program, the restrictive reception unit restricting viewing for charged broadcasting service;
32-bit expiration data for indicating the expiration time of the program;
32-bit starting time data for indicating the starting time of the program;
16-bit initial free preview duration data for indicating free preview time from the starting time of the program;
16-bit anytime free preview duration data for indicating free preview time during the showing of the program; and
text data for showing purchase options of the program and the description on the purchase options.
